(19) United States
(12) Patent Application Publication
(10) Pub. No.: US 2008/0083475 A1
(43) Pub. Date: Apr. 10, 2008

(54) Beverage Fill Level Detection and Indication

(76) Inventor: George William Lamb, Atlanta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/539,732

(22) Filed: Oct. 9, 2006

(51) Int. Cl. B65B 3/26; B65B 1/30; B67C 3/02

(52) U.S. Cl. 141/198; 141/83; 141/95

(57) ABSTRACT

Beverage fill detection apparatuses may take the form of a coaster, where opaque beverage containers are placed on top, and a fill level for the beverage container is indicated. The apparatus includes a pressure sensor which determines the pressure associated with the beverage container, and based on comparisons to one or more reference values, determines a fill level of the beverage container and displays the fill level.

### BACKGROUND

The use of aluminum beverage bottles for the transportation and service of beverages has become more common in recent years. Aluminum bottles have the combined advantage of providing enhanced protection against ultraviolet rays and providing significantly better insulation than glass bottles. Unlike their glass predecessors, however, these aluminum bottles have a specific disadvantage. Since they are by their nature completely opaque, it is nearly impossible to visually determine the fill level of the container. This may make it difficult for beverage consumers and bartenders to judge whether an aluminum bottle is empty or almost empty without picking up the bottle and guessing. Problems judging beverage fill level are not limited to aluminum bottles and may affect any beverage container which is opaque or partially opaque, including glass bottles with large opaque labels, for example. These problems may exist in low-light settings, for example bars and nightclubs, and affect all beverage containers.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Provided are apparatuses for the detection and indicate the fill level of a beverage container. The apparatus includes a pressure-sensitive area upon which the beverage container is placed, and an indicator that indicates the fill level. Embodiments of the apparatus may utilize an integrated circuit in communication with the pressure-sensitive area and indicator. Embodiments of the apparatus may include rechargeable batteries to supply power.

Also provided are methods for the detection and indication of a beverage fill level. Embodiments of the methods include receiving a signal from a pressure-sensitive sensor, where the beverage container exerts pressure on the sensor, determining the fill level of the beverage container, and providing an indication of the fill level of the beverage container. Determining the fill level may include comparing a value associated with the signal from the pressure-sensitive sensor to reference minimum and maximum values for the beverage container.

Other apparatuses, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts a top-front isometric view of a beverage fill detection apparatus according to one or more embodiments described herein;

FIG. 2 depicts a bottom-rear isometric view of a beverage fill detection apparatus according to one or more embodiments described herein;

FIG. 3 depicts a counter having multiple beverage fill detection apparatuses installed according to one or more embodiments described herein;

FIGS. 4A-4C depict beverage fill feedback mechanisms according to several embodiments described herein;

FIG. 5 is a schematic for a beverage fill detection apparatus according to one or more embodiments described herein;

FIG. 6 is a series of rechargeable beverage fill detection apparatuses placed in a charging configuration according to one or more embodiments described herein; and

FIG. 7 is a flowchart showing a process for operation of a rechargeable beverage fill detection apparatus according to one or more embodiments described herein.

### DETAILED DESCRIPTION

The following detailed description is directed to an apparatus and method for detecting and indicating the fill level of a beverage container. In the following detailed description, references are made to the accompanying drawings that form a part hereof, and which are shown, by way of illustration, using specific embodiments or examples. Referring now to the drawings, in which like numerals represent like elements through the several figures, aspects of the apparatus and methods provided herein will be described.

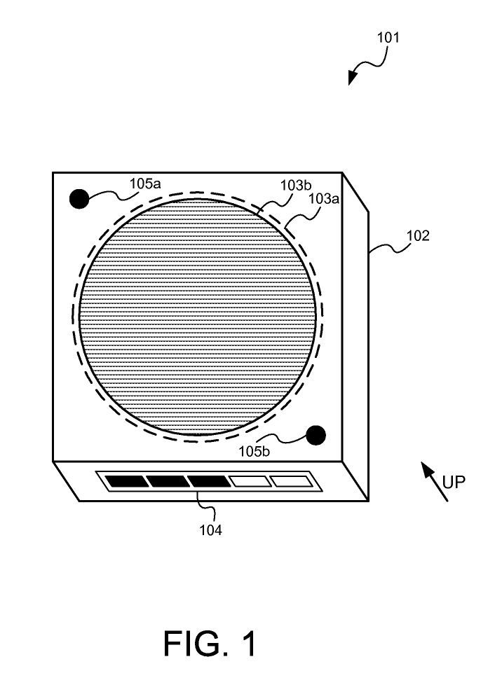

FIG. 1 depicts a top-front isometric view of a beverage fill detection apparatus 101 according to one or more embodiments of the invention. The example embodied by beverage fill detection apparatus 101 may be referred to as a “smart” coaster 101. Other embodiments may not take the form of a coaster, nevertheless components and operations described with reference to the smart coaster 101 may be applicable to other embodiments of the beverage fill detection apparatus 101.

The smart coaster 101 is comprised of a housing 102 for use as a coaster for a beverage container (not shown). Housing 102 The smart coaster 101 is intended to sit on a flat surface and provide a surface upon which the beverage container can rest. The smart coaster 101 includes a pressure-sensitive area 103a. The pressure-sensitive area 103a may be a flexible pressure-sensitive portion of housing 102. Alternatively, housing 102 may have an opening in which a pressure-sensitive plate distinct is mounted, and which may be covered by a rubber membrane 103b. The rubber membrane 103b may be configured to create a liquid tight seal in order to prevent moisture from invading the housing 102. The rubber membrane 103b may also be pre-printed with images of promotional, advertising, or other art or messages. The rubber membrane 103b may further be affixed to housing 102 in such a way as to be easily replaced, allowing worn membranes to be replaced or printed images to be updated. The pressure-sensitive area 103a may produce electrical, mechanical, magnetic, or any other force or output which can be utilized to detect a fill level of the beverage container. The pressure-sensitive area 103a may include a beveled or sunken region in order to guide users in the placement of a beverage container on top of the smart coaster 101. Other pressure-sensitive configurations may be utilized, including for example an exterior pressure-sensitive plate mounted to housing 102.

The housing 102 of the smart coaster 101 may include an opening or transparent area committed to a fill level display 104. The fill level display 104 is for displaying fill level information. Fill level display 104 may include a liquid crystal display (LCD) with a fill level gauge, as shown. Fill level display 104 may also or alternatively be a mechanical fill-level gauge such as a moving needle. In other embodiments, fill level information may not be shown on a gauge, but instead displayed using a light whose color or brightness represents different beverage fill levels. In further embodiments, fill level information may be indicated using an audible alert from an audio speaker, where the audible alert changes based on fill level. For example, the alert may be in the form of a spoken voice, or a pitched or varying tone. Fill level information may be provided by the smart coaster on an ongoing basis in some embodiments, or it may be provided when prompted by depressing a button (not shown), making an audible command (e.g., a snap or a clap), or using another input.

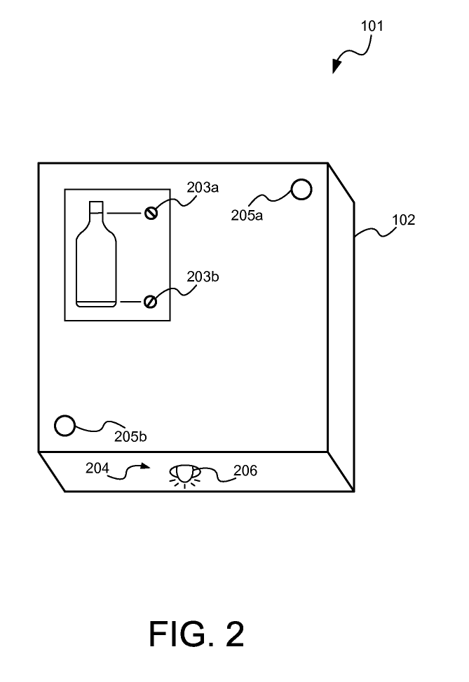

The smart coaster 101 is shown in a rechargeable configuration in the embodiment of FIG. 1. In this and similar embodiments, fill level information is detected and indicated with the use of electrical power. To supply power, the smart coaster 101 includes a rechargeable battery which can be recharged using charging posts 105. Electric current may be applied to the posts 105 which may then be utilized to recharge the rechargeable battery of the smart coaster 101, and also to supply charging current to other smart coasters in contact with the smart coaster 101. In some embodiments, electric power may be supplied via from an exterior power supply via an electric wire or wires. Replaceable batteries may also be utilized. In alternative embodiments, mechanical power may be utilized, preventing the need for any electrical power source. Additional details with regard to the exterior of the smart coaster 101 are supplied below with respect to FIG. 2.

FIG. 2 depicts a bottom-rear isometric view of the smart coaster 101 according to one or more embodiments of the invention. The bottom of housing 102 includes charging insets 205, which are intended for rechargeable configurations and can receive the charging posts 105 of another smart coaster device, or the charging posts of a charging base. As with the charging posts 105, the charging insets 205 can receive charging current to recharge an internal battery and also to supply charging current to other connected coasters. The rear of housing 102 includes a power level indicator 204 in the form of light emitting diode 206 (LED), which may be a two-color LED. The power level indicator 204 may double as or alternatively be used as an additional fill level indicator for the back of the smart coaster 101. In the situation where LED 206 is utilized as a fill level display, it may be used by bartenders to quickly view when a beverage is empty or almost empty. For example, a two-color LED 206 may provide constant illumination with a green color when a beverage container is at least half full. If the container is less than half full, the two-color LED 206 may stay constantly red. If the container is empty, the LED 206 may flash red. Other types of power level indicators 204 may be utilized to indicate a current power level in embodiments utilizing a battery, including for example, a separate LCD, or it may be integrated into the fill level indicator 104 of the smart coaster 101.

The smart coaster 101 may include adjustment inputs 203 to be used when calibrating the smart coaster 101 for different beverage containers. Adjustment inputs 203 may include only a maximum adjustment input 203a, only a minimum adjustment input 203b, or both. The adjustment inputs 203 may take the form of screws, knobs, or other input components which allow for multiple adjustment levels. The adjustment inputs 203 may be used to set an empty and/or a full level for a particular type of beverage container. A user may alter an input 203 to ensure that the fill level information indicated for a particular beverage container is accurate. For example, a user may place an empty beverage container on the smart coaster 101 and adjust a minimum adjustment input 203b (e.g., rotate a screw), making sure that the fill level indicator 104 accurately indicates an empty container. This process may be repeated with a full beverage container and the maximum adjustment input 203a. Correctly adjusted, the fill level indicator 104 would indicate half-full when a half-empty container is placed on the coaster.

The reference values provided by adjustment inputs 203 may vary depending on beverage container. As such the reference values may be stored and selected depending on the brand, size, material, or other beverage container properties. A selection may be made using buttons or other input devices associated with a smart coaster 101. Alternatively, smart coaster 101 may sense the type of beverage container in use based on container footprint, or other determinative aspects of the container.

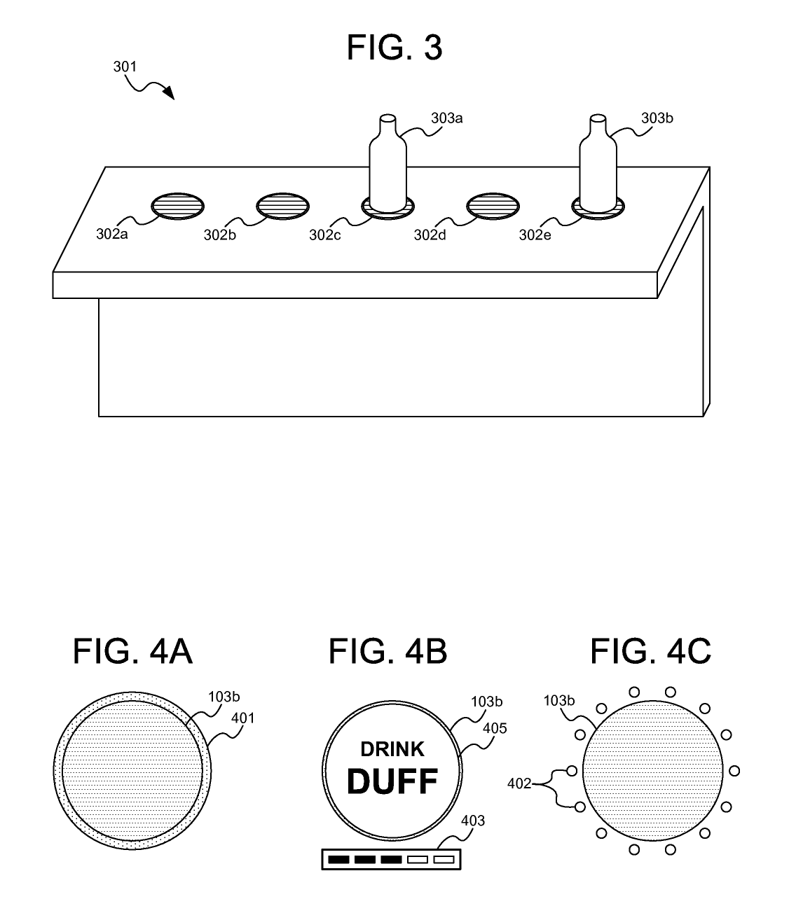

FIG. 3 depicts one or more alternative embodiments of beverage fill detection apparatus 101. FIG. 3 depicts a counter 301 having multiple counter coasters 302 installed according to one or more embodiments of the invention. The counter 301 may be a bar counter, or any other flat surface where the beverage containers 303 may be placed. The counter coasters 302 may include pressure-sensitive areas 302, similar to the pressure-sensitive area 103a of FIG. 1. The counter coasters 301 may also include rubber membranes, similar to the rubber membranes 103b of FIG. 1. Operation of the counter coasters 301 is similar to that described for the smart coaster 101. Fill level information may be provided through multiple indications, some of which are described below with respect to FIGS. 4A-4C. Individual counter coasters 302 may, if needed, be supplied power from a common source such as a conventional 120V alternating current wall socket. Adjustment level inputs may be provided via individual inputs for each counter coaster 302 and hidden from customer view behind or underneath the counter 301. Alternatively, one set of adjustment level inputs may be utilized for use by all the counter coasters 302.

FIGS. 4A-4C depict top views of fill level information displays according to multiple embodiments of the invention. FIG. 4A depicts a rubber membrane 103b, encircled by a fiber optic light source 401. A properly calibrated coaster (smart coaster 101 or counter coaster 302) may light up with different colors, intensities, or flashing patterns using fiber optic light source 401. The glow created by the fiber optic light source 401 can provide a beverage consumer a quick way of seeing the fill lever of his or her beverage container 303. The glow may also alert a bartender to an empty beverage container 303 needing a refill. For example, a full beverage container may cause fiber optic light source 401 to glow with a very dim green light. As the beverage is consumed, the light source 401 may begin to glow brighter and slowly change to red. When the beverage is totally empty, the light source 401 may then begin to flash to get the attention of the consumer or a service person.

FIG. 4B depicts a rubber membrane 103b coupled with an LCD display 104. The display 403 may appear on the same surface as the rubber membrane 103a, or on a separate surface, such as with the smart coaster 101. As a beverage container 303 is emptied, the number of illuminated bars on the display 403 may decrease, eventually showing no bars when the beverage container 303 is empty. Other forms of output may be shown on the LCD display 403, including the words “Empty” and “Full,” or any other indication of fill level. The rubber membrane 103b may include a promotional message 405 as shown in FIG. 4B. The promotional message 405 may be an advertising revenue source for a beverage supplier, or an advertiser may provide the printed rubber membranes 103b for free to a beverage provider.

FIG. 4C depicts a rubber membrane 103b encircled by a series of LEDs 402. The LEDs, 402 as with the fiber optic light source 401, may light up with different colors, intensities, or flashing patterns depending on the fill level of a beverage container 303 placed on rubber membrane 103b. Alternatively, the LEDs 402 may be selectively lit in order to provide a gauge similar to LCD display 403. For example, of the 14 LEDs 402 shown in FIG. 4C, only 2 LEDs may be lit when the beverage container 303 is almost empty, whereas all 14 LEDs 402 may light up when the beverage container 303 is full.

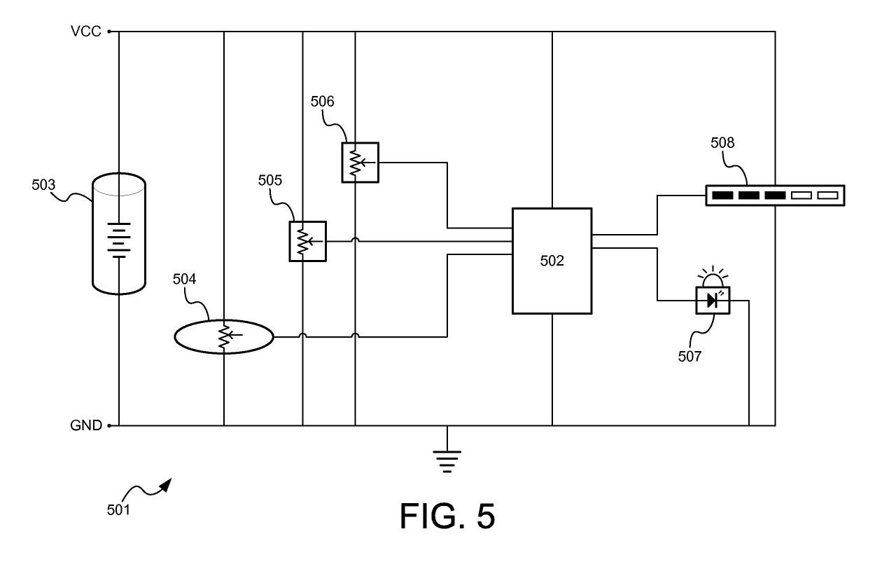

FIG. 5 is a schematic for a circuit 501 for use with a beverage fill detection apparatus 101 according to one or more embodiments of the invention. Apparatuses 101 not requiring electricity may use a mechanical method for detecting and indicating a fill level which does not require the use of circuits like the circuit 501. The schematic 501 is intended to show functional components of the circuit 501 and should not be viewed as limiting as to components which must or must not be included in a beverage fill detection apparatus 501. Additional components not shown may be added, and components shown may be combined, separated, and/or removed.

The circuit 501 includes a power source 503 to provide the voltage required to drive the circuit. The power source 503, as discussed above, may include a disposable battery (e.g., AAA battery), a rechargeable battery, an external power source, or other power supply. If power source 503 is a rechargeable battery, the charging posts 105 and the charging insets 205 may be electrically connected to ground GND and common-collector voltage VCC in circuit 501. The circuit 501 also includes a pressure-sensitive plate or sensor 504, which may be composed of a potentiometer whose resistance changes based on pressure applied to the pressure-sensitive plate. Also included are the adjustment inputs 505 and 506, which also may be composed of potentiometers whose resistance changes based on adjustments made to the respective input.

The circuit 501 also includes an integrated circuit (IC) 502 which receives inputs and produces outputs in order to detect and indicate fill level information. The IC 502 may be composed of a single chip or multiple chips as needed. The IC 501 may include a microprocessor, a microcontroller, an application specific integrated circuit (ASIC), a complex programmable logic device (CPLD), a field programmable gate array (FPGA), or any other device capable of detecting and indicating fill level information. The IC 502 may receive analog signals or digital values from the pressure-sensitive sensor 504 and the adjustment inputs 505 and 506. Using a stored set of instructions or a hardwired state machine, the IC 502 may convert any analog signals to digital values, and determine fill level information. This may be accomplished by comparing the pressure value from the pressure-sensitive sensor 504 with the reference values of the adjustment inputs 505 and 506. Based on the comparison, the IC 502 may send control signals to the output devices to indicate the fill level information, or the IC 502 may simply send a driving current to control the output devices directly (e.g., drive an LED). Output devices may include fill level indicator 508 and power level indicator 507. Output devices 507 and/or 508 may be composed of any of the output devices described above with respect to FIGS. 4A-4C, as well as the LED 206 of FIG. 2.

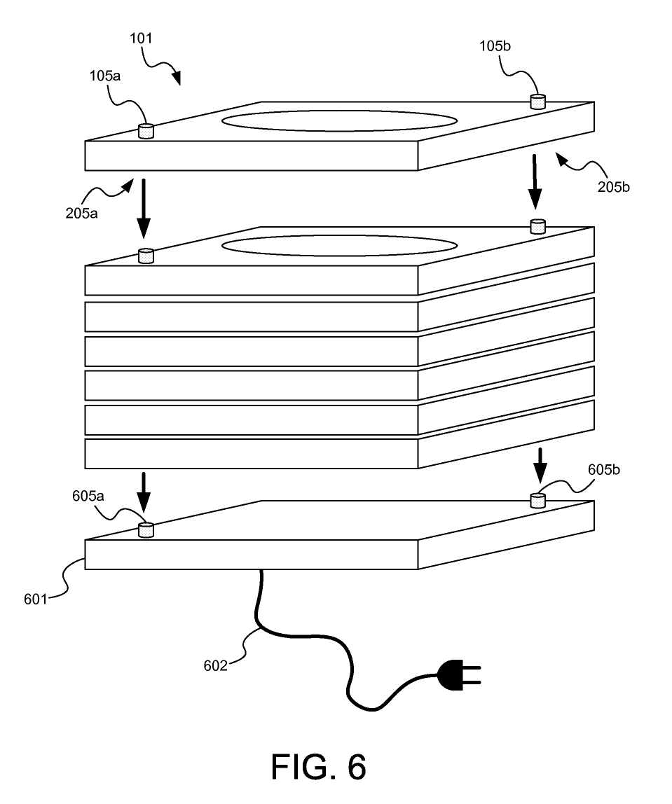

Turning to FIG. 6, depicted is a series of rechargeable smart coasters 101 placed in a charging configuration according to one or more embodiments of the invention. Smart coasters 101 are stacked so that charging current can be applied to multiple coasters simultaneously. The charging insets 205 of each coaster 101 are placed upon the charging posts 105 of the coaster below it. At the bottom of the stack of coasters, the charging insets 205 of the bottom coaster are placed on the charging posts 605 of the charging base 601. Charging current may be supplied through successive posts 105a and insets 205a to all coasters on one side of the stack and returned through successive posts 105b and insets 205b on the other side of the stack. Posts 105 and insets 205 may be keyed so as to prevent improper placement of devices atop each other. Charging base 601 has its own power source, in this case a conventional plug 602.

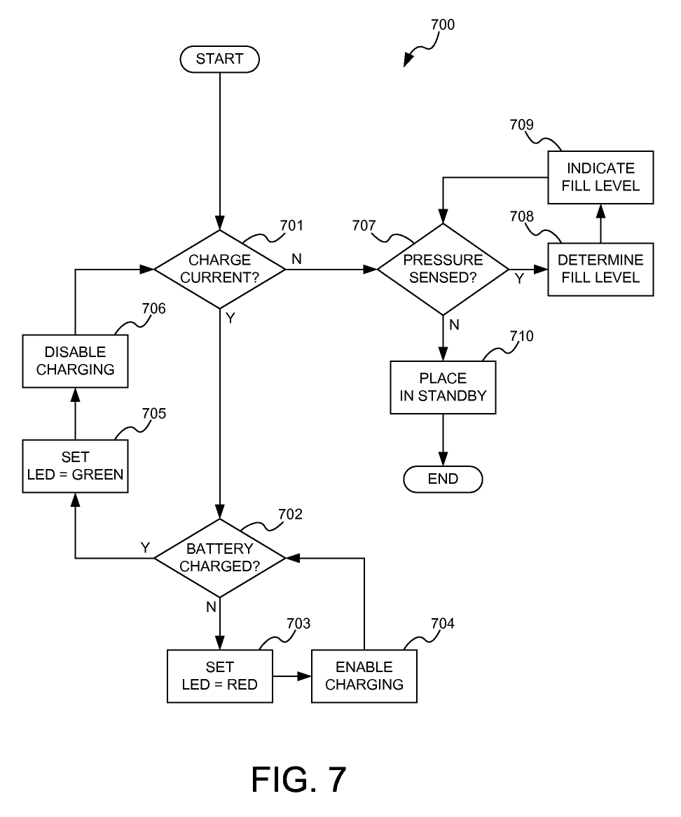

Turning to FIG. 7, depicted is a flowchart showing a process 700 for operation of a rechargeable beverage fill detection apparatus 101 according to one or more embodiments of the invention. The logical operations of the process 700, and of the various embodiments presented, may be (1) a sequence of processor instructions or program modules running on IC 502 and/or (2) interconnected machine logic circuits or circuit modules within IC 502. The implementation is a matter of choice dependent on the performance requirements of the computer on which the embodiments are implemented. Accordingly, the logical operations making up the implementations are referred to variously as operations, structural devices, acts, or modules. It will be recognized by one skilled in the art that these operations, structure devices, acts, and modules may be implemented in software, in firmware, in special purpose digital logic, and/or any combination thereof without deviating from the spirit and scope of the attached claims. Moreover, it will be apparent to those skilled in the art that the operations described may be combined, divided, reordered, skipped, and otherwise modified, also without deviating from the spirit and scope of the attached claims.

At the decision 701, a rechargeable beverage fill detection apparatus 101 may first determine whether a charging current is presently being applied to the apparatus. If a charging current is being applied across the posts and/or insets, then the apparatus will enter a charging mode at the decision 702. If the rechargeable battery 503 is not fully charged, then at the operation 703, a power level indicator 204 in the form of an LED 206 is set to red. At the operation 704, charging is enabled for the rechargeable battery 503. The power level of the battery 503 is re-checked, and once it is fully recharged, then at the operation 705, the LED 206 is set to green, and at the operation 706, charging is disabled.

Returning to the decision 701, if a charging current is not being applied, then at the decision 707, the state of the pressure-sensitive plate 504 is checked. If no pressure is sensed, then the apparatus 101 may be placed in a standby state at the operation 710, which may include a low-power state to conserve the battery 503. If pressure is sensed at decision 707, then at the operation 708, a fill level is determined. The determination may be made utilizing the process discussed above with respect to circuit 501, utilizing inputs from the pressure-sensitive plate 504 and the adjustment inputs 505 and 506. Once a fill level is determined, the fill level is indicated at the operation 709 or otherwise indicated for use by a beverage consumer or beverage provider. As the fill level of the beverage container changes, the fill level is re-determined and indicated until pressure is no longer sensed. At this point, the beverage fill detection apparatus 101 may be placed in a standby state.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. An apparatus for the detection and indication of the fill level of a beverage container, the apparatus comprising:
a pressure-sensitive area, upon which the beverage container is placed;
a first indicator, indicating a fill level of the beverage container based upon pressure exerted by the beverage container on the pressure-sensitive area.

2. The apparatus of claim 1, further comprising:
an integrated circuit, in communication with the pressure-sensitive area and with the first indicator and operative to cause the first indicator to indicate the fill level of the beverage container in response to signals received from the pressure-sensitive area.

3. The apparatus of claim 2, further comprising:
a housing, wherein the housing encloses the processor, and wherein the housing comprises portions for the pressure-sensitive area and the first indicator; and
a rubber membrane, overlaying the pressure-sensitive area.

4. The apparatus of claim 3, wherein the rubber membrane comprises an image.

5. The apparatus of claim 3, further comprising:
a power source, enclosed by the housing;
a second indicator, indicating a power level of the power source, and wherein the housing comprises an opening for the second indicator.

6. The apparatus of claim 5, wherein the second indicator comprises a light emitting diode.

7. The apparatus of claim 2, further comprising:
a first adjustment input, in communication with the integrated circuit, and wherein the integrated circuit is operative to calibrate a maximum fill level measurement using input received from the first adjustment input.

8. The apparatus of claim 7, further comprising:
a second adjustment input, in communication with the integrated circuit, and wherein the integrated circuit is operative to calibrate a minimum fill level measurement using input received from the second adjustment input.

9. The apparatus of claim 8, wherein the first and second adjustment inputs comprise potentiometers.

10. The apparatus of claim 1, wherein the first indicator comprises a liquid crystal display.

11. The apparatus of claim 1, wherein the first indicator comprises an audio speaker.

12. A method for providing a fill level of a beverage container, the method comprising:
receiving a signal from a pressure-sensitive sensor, wherein the beverage container exerts pressure on the pressure-sensitive sensor;
determining the fill level of the beverage container; and
providing an indication of the fill level of the beverage container.

13. The method of claim 10, wherein determining the fill level of the beverage container comprises:
comparing a pressure value associated with the pressure-sensitive sensor with a first reference value;
converting the result of the comparison to a fill level.

14. The method of claim 11, wherein determining the fill level of the beverage container further comprises comparing the pressure value to a second reference value.

15. The method of claim 12, wherein determining the fill level of the beverage container further comprises:
receiving a first signal from a first adjustment input;
determining the first reference value using the first signal;
receiving a second signal from a second adjustment input; and
determining the second reference value using the second signal.
